(19) United States
(12) Patent Application Publication
(10) Pub. No.: US 2014/0181895 A1
(43) Pub. Date: Jun. 26, 2014

(54) Off campus wireless mobile browser and web filtering system

(71) Applicant: BARRACUDA NETWORKS, INC., Campbell, CA (US)

(72) Inventor: Raymond Kelly, Loganville, GA (US)

(73) Assignee: BARRACUDA NETWORKS, INC., Campbell, CA (US)

(21) Appl. No.: 13/726,927

(22) Filed: Dec. 26, 2012

(51) Int. Cl. H04W 12/08

(52) U.S. Cl. CPC H04W 12/08; H04L 63/107
USPC 726/1; 726/5

(57) ABSTRACT

A mobile wireless safe browser receives a destination link, host, uniform resource identifier, or Internet Protocol address. Prior to requesting a resource from the destination, the safe browser transmits a query over the air to a reputation service and receives a messages enabling or disabling conventional browser request for IP address or resources at the destination host. The user is identified to a reputation service which maintains categories of websites and a policy file for each user which enables or disables access to each category .

### RELATED APPLICATIONS

None.

### BACKGROUND

A mobile wireless device easily escapes the campus or the corporate network. So you are not typically protected/filtered by the local network(like a Barracuda Web Filter). A mobile device can reach the Internet via 3G, 4G, and WiFi at any location and is vulnerable to any malicious or heart-breaking content hosted in the world. When mobile wireless devices are outside their home network campus, they are no longer protected by firewalls, web filters, or gateways located at the end of a network. However devices provided by schools or enterprises may have liabilities when exposing their users to undesirable content. Conventional systems are content based rather than user identity based. Thus it can be appreciated that what is needed is flexible web filtering for individual mobile wireless devices.

### BRIEF DESCRIPTION OF DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1-4 are block diagrams of a system and FIG. 5-6 are flow charts of method steps.

### SUMMARY OF THE INVENTION

A policy driven browser is connected to a policy server which receives a requested web host id or domain name from the wireless mobile browser along with user identity authentication. If the browser is redirected to another destination, the policy server receives the new host id or domain name and checks with a policy for that specific user.

The reputation of the host id or domain name is stored at the policy server along with a specific policy for each authenticated user. The policy server replies to the policy driven browser to proceed or deny access to the requested web host id.

A policy determines each individual user, his or her access to web hosts. The system is easily distinguished from proxies that examine all content or block lists which are not specific to a certain user.

### DETAILED DISCLOSURE OF EMBODIMENTS

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

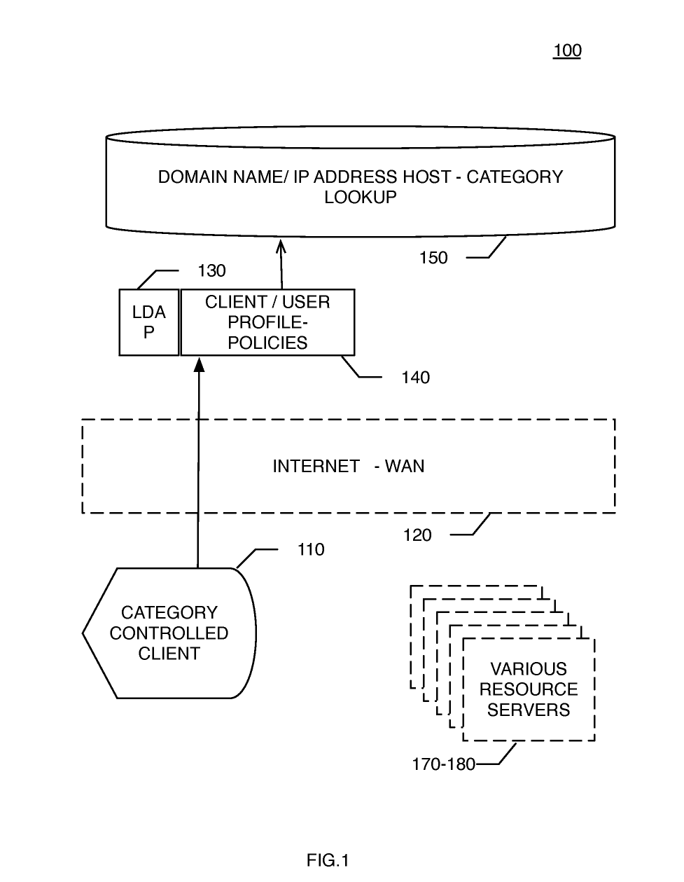

Referring now to FIG. 1, a system 100 comprises a wireless category controlled client 110 such as a mobile phone communicatively coupled through a wide area network 120 such as the Internet, to an authentication circuit 130 such as an LDAP server. The wireless category controlled client transmits a request for a resource provisioned at various resource servers 170-180. After authenticating the user operating the wireless category controlled client, the system reads a client/user profile policy apparatus 140 which enables or denies access to various categories of resources. The system further comprises a domain name/IP address/host category lookup store which records the categories for content on the various resource servers. Such content may be of several categories. Rather than determining a white list or black list for all users or for each user, the contents of each resource server is determined to be in at least one category. The user profile-policy for each authenticated user either denies or allows access to specific categories. A policy could also admit or deny access to uncategorized hosts to certain identities.

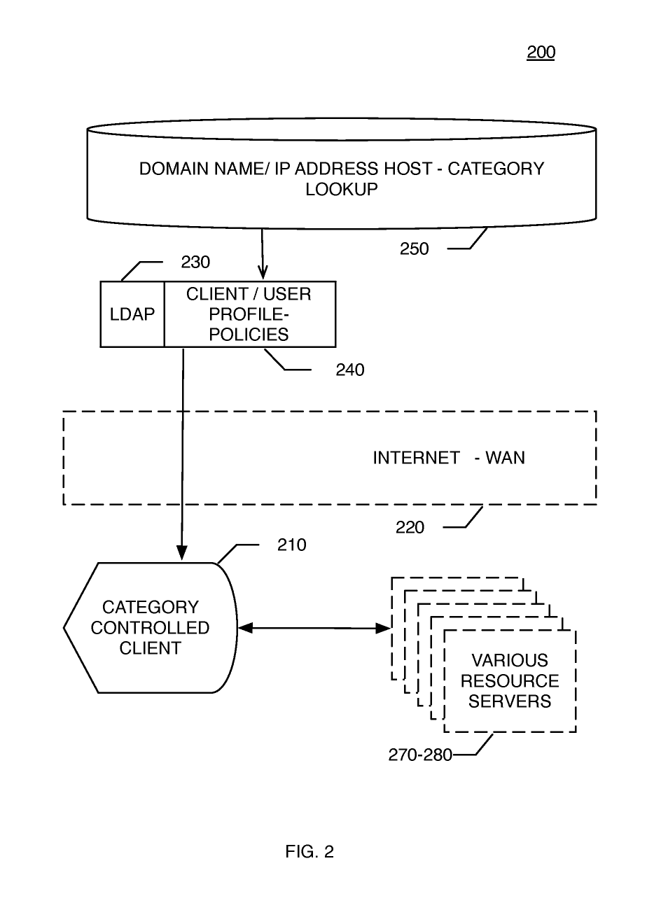

Referring now to FIG. 2, the system 200 further comprises a communication channel from the client/user profile policy apparatus to the wireless category controlled client 210 which transmits an allowance or denial of access to the requested resource server 270-280. Note that the decision is based on the authenticated identity of the user and his or her profile policy. A different user may not have the same access even operating the same wireless category controlled client 210. If a category is denied according to the user profile policy, no request to the resource server will be made at all, minimizing traffic. In contrast a conventional white list or black list enables or disables every user within a network from access.

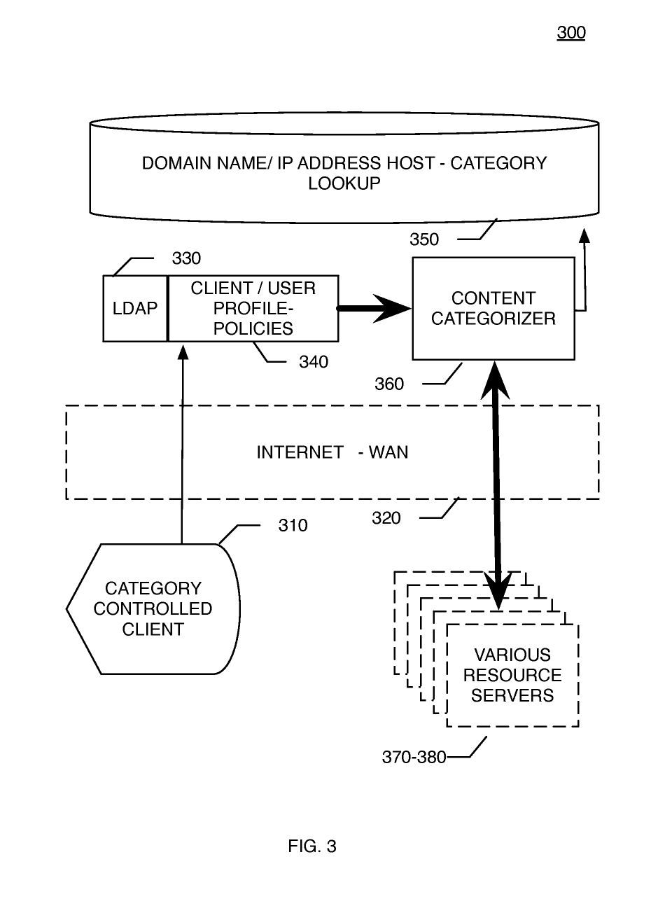

Referring now to FIG. 3, the system 300 further comprises a Content Categorizer circuit 360 communicatively coupled to a plurality of various resource servers 370-380. When the client/user profile-policy engine is unable to find a requested resource in the Category Lookup Store 350, the resource is first marked “Uncategorized” by the content categorizer 360 and subsequently remarked based on the analysis of the content at the resource server or their redirection results. In an embodiment, a user profile policy will deny access to an uncategorized resource server. In an embodiment, user profile policy will allow access to an uncategorized resource server. In an embodiment, a user profile policy will wait or retry, enabling the content categorizer 360 to make a determination of a category and update the category lookup store 350.

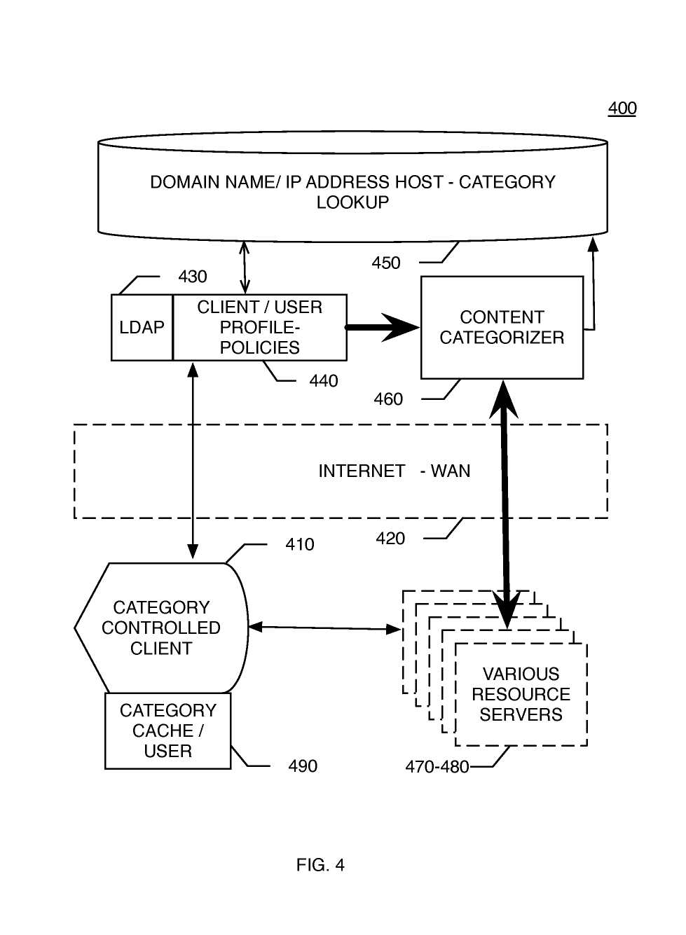

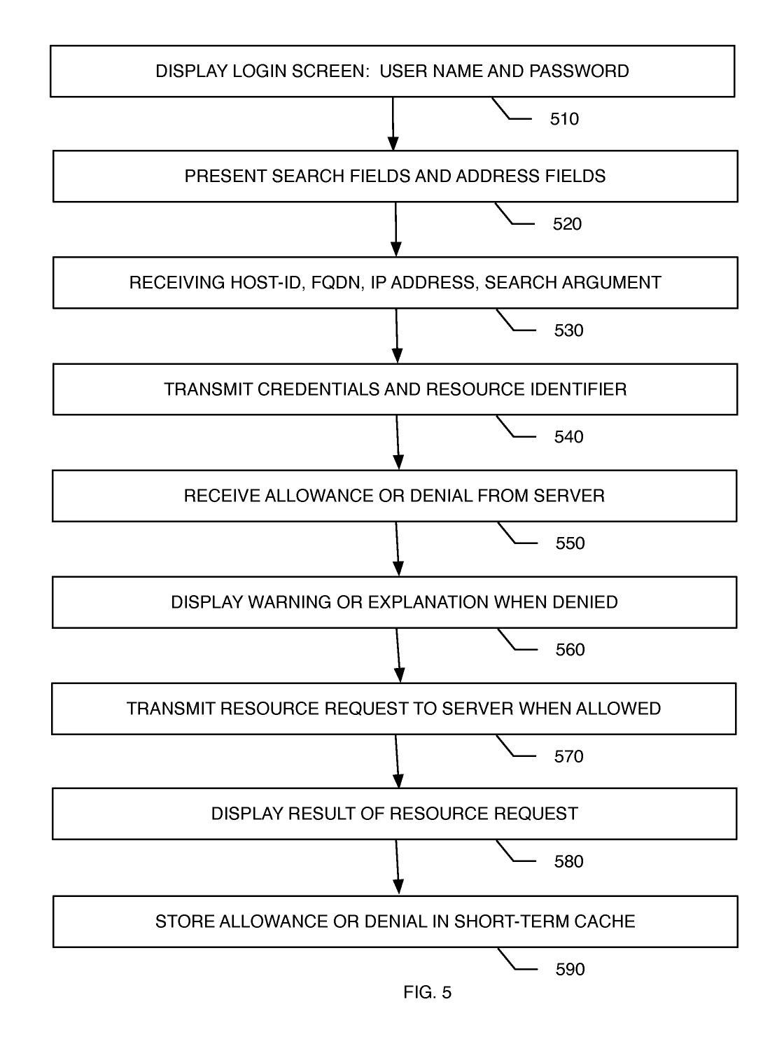

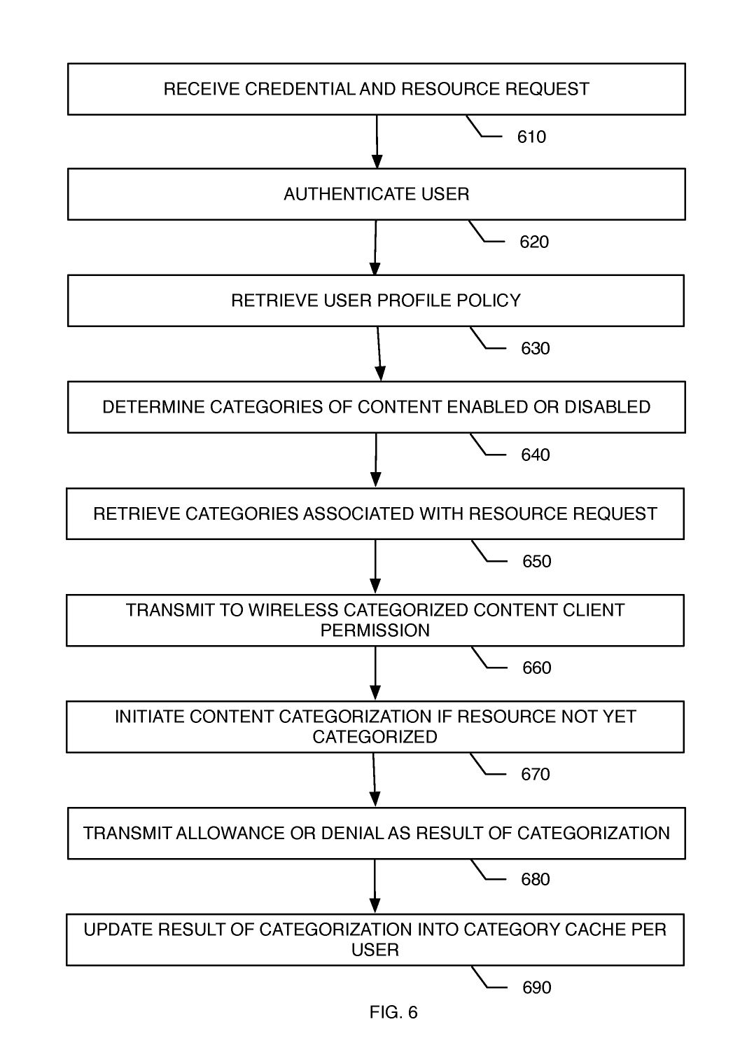

Referring now to FIG. 4, the system 400 further comprises a communication channel to the wireless category controlled client 419 from the Client/User Profile-Policies apparatus whereby access to one of the various resource servers is denied or allowed. In an embodiment, a Category Cache per User 490 store coupled to the Wireless Category Controlled Client device stores recently determined denials or allowances as a short-term performance improvement. A message is displayed to the user when a category is denied according to the user-specific profile policy.

Referring to FIG. 5 is a method for operating a wireless category controlled client device, such as a mobile phone or tablet. Upon being invoked by a user action, displaying 510 a login screen comprising data entry fields for user name and password, presenting 520 a conventional browser user interface with search fields and address fields, receiving 530 a host-id in the form of a fully qualified domain name, Internet Protocol address, or search argument, transmitting, 540 through a wireless channel, credentials and the resource identifier to a server, receiving 550 from said server a response to a resource request as an allowance or a denial, upon receiving a denial 560, displaying 561 a warning or explanatory message to the user, upon receiving an allowance 570, transmitting 571 the resource request to a server located by the uniform resource identifier or IP address, and displaying the result of the resource request 580.

In an embodiment, the method further comprising storing 590 the allowance or denial is short-term cache for improved latency on subsequent requests.

Referring to FIG. 6, a method for operating a server to authorize access to categorized resources comprising: receiving from a wireless category controlled client device such as a mobile phone or tablet an authentication credential and a resource request 610; authenticating the user as a member of a group 620; retrieving a user profile policy for the authenticated user 630; determining the categories of content enabled or disabled to the user 640; retrieving the categories of content associated with the requested resource server 650; and upon the condition of allowance, transmitting to the wireless category controlled client device a signal to request the resource from the server 660.

In an embodiment, the method further comprises, on the condition that the content of the requested resource server has not previously been categorized, initiating a content categorizer module to store the resource as uncategorized, retrieve content and redirection instructions from the requested resource server, and replace the uncategorized label with a category for the content, meta data, and redirection instructions 670.

In an embodiment, the method further comprises, transmitting to the wireless category controlled client device a denial or an allowance to retrieve the resource 680, and in an embodiment, updating the result of the categorization into a category cache per user store coupled to the category controlled client device to improve latency for additional requests 690.

In embodiments, the most commonly accessed resource identifiers may be downloaded to each category controlled client with preapproval according to the user's profile policy. In embodiments, the category controlled client is installed on certain hardware and other browsers are disabled or removed from user access. In embodiments, each user is authenticated to the category controlled client and the user identity is transmitted with a request for a resource to enable the client/user profile-policy server to determine when the access is denied. In embodiments, uncategorized resource identifiers may be enabled or disabled according to the user profile-policy.

The invention is easily distinguished from conventional white lists and block lists or black lists by being sensitive to the time of day, role, location, and identity of the wireless client user. And the recategorization of a resource identifier can be reiterated automatically as the content and redirection are dynamic. Finally, the method does not prevent a search from returning results that point to resources but does control the subsequent access to the resource.

The LDAP module verifies the user of the mobile device. Each individual user of a safe browser must “login”. By authenticating the browser and service server determines that “Ray” is browsing the net and to block content based on Ray's personalized ruleset. Conventional content blockers depend on gross cohort rulesets e.g. all junior high school age.

In embodiments, host-ids of servers on the user's local disk, local network, or campus or employer, or authenticated partners are stored locally in category cache for each user. The category cache may be purged or expire over time. In embodiments, the most commonly accessed resource identifiers may be downloaded to each category controlled client with preapproval according to the user's profile policy.

In embodiments, the category controlled client is installed on certain hardware and other browsers are disabled or removed from user access. In embodiments, each user is authenticated to the category controlled client and the user identity is transmitted with a request for a resource to enable the client/user profile-policy server to determine when the access is denied. In embodiments, uncategorized resource identifiers may be enabled or disabled according to the user profile-policy.

The invention is easily distinguished from conventional white lists and block lists or black lists by being sensitive to the identity of the client user. And the recategorization of a resource identifier can be reiterated automatically as the content and redirection are dynamic.

Unlike conventional web filters the method is individualized. LDAP in the cloud verifies the identity.

Given an identity, the safe browser asks the policy server to enable or disable a request to a web host. We do this by making the user provision their Safe Browser and making the user login. We validate the user using LDAP in the cloud.

Another aspect of the invention is to control processors to perform the following process: 1. Receive a request to provision a safe browser to a specific device. 2. Download browser configured to a specific device id and store. 3. Receive a request to login from a specific user from a provisioned device. 4. Authenticate user by LDAP and establish a session. 5. Receive a domain name from a specific user on a provisioned device. 6. Check category of the domain name and user's specific policy on that category. 7. Enable or disable browser to open a protocol with the domain name.

In an embodiment, the invention includes formatting and transmitting a query to a reputation service, the query comprising a user identity, and a fully qualified domain name. In an embodiment, the invention includes formatting and transmitting a query to a reputation service, the query comprising a user identity and a desired destination Internet Protocol (IP) address. In an embodiment, the query is formatted as a UDP request packet. In an embodiment, the query is formatted as an HTTP request. In an embodiment, the query is formatted as an HTTPS request. An advantage of transmitting a UDP packet is that a domain name system type of request and response is more likely to pass through a firewall without interference. In an embodiment, the query is transmitted through a virtual private network, ie. a tunnel, to traverse any firewalls or gateways. An advantage of transmitting a query through a virtual private network tunnel is that the user is easily identified to the reputation service and the denial or enablement of access to the desired destination is customized to the policy which applies to the individual user. By using a virtual private network, the identity of the user is more protected by the certificate.

Unlike conventional systems the enablement or denial of access to websites is not based on age ranges.

### CONCLUSION

The present invention applies protection and filtering to all connections regardless of location or method.

The techniques described herein can be implemented in digital electronic circuitry, or in computer hardware, firmware, software, or in combinations of them. The techniques can be implemented as a computer program product, i.e., a computer program tangibly embodied in a machine-readable storage device for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

I claim:

1. A method for operation of a reputation service by a processor communicatively coupled to a mobile wireless device configured with a mobile wireless safe browser, the method comprising:
receiving a query from a user of a mobile wireless safe browser,
authenticating the user identity,
retrieving from storage a user policy for access to categories of web hosts,
determining a category for the web host contained within the query, and
returning a reply to the user according to the user policy on the queried web host.

2. A method for operation of a mobile wireless device configured with a mobile wireless safe browser:
receiving a network destination comprising one of a web host name, fully qualified domain name, a link, a uniform resource identifier, or an Internet Protocol (IP) address;
transmitting over the air a query to a reputation service, the query containing user identity information and the network destination;
receiving from the reputation service an enablement or disablement message;
at least one of displaying a message to the user that access is denied and operating a conventional http protocol request.

3. The method of claim 2 wherein the user identity information is based on a certificate.

4. The method of claim 2 wherein the user identity is a password and user name combination.

5. The method of claim 2 wherein the query is in the form of a domain name system request.

6. The method of claim 2 wherein the query is in the form of an HTTP protocol request.

7. The method of claim 2 wherein the query is in the form of an HTTPS protocol request.

8. The method of claim 2 wherein the transmitting comprises opening a virtual private network tunnel to a reputation service server.

9. A system for enabling or denying access to web resources at a mobile category controlled client comprising:
at least one mobile category controlled client, comprising a baseband processor, transceiver circuits, memory, network interfaces, and an application processor, the application processor configured to operate a browser;
at least one client/user profile-policy server, the profile-policy for each authenticated user to deny access to certain categories of content during proscribed times and dates;
a non-transitory computer readable store encoded with domain names, ip addresses, host-ids, and other resource identifiers which have been categorized into categories; and
a content categorizer system which applies rules and heuristics to categorize and recategorize host-ids, domain names, and Internet Protocol addresses by content and stores the resulting duple into a lookup table encoded on the non-transitory computer readable store; all elements communicatively coupled through conventional local and wide area networks.

10. A method for operating a category controlled client which has conventional display, processor, memory, network connections, authentication circuits, and a category cache organized by user, the method comprising:
receiving a resource identifier (link, url, redirection, manual entry, . . . );
checking local category cache for recent access allowance or permanent enablement (your school, your campus, your enterprise, your own disk/intranet);
transmitting authentication credentials and the received resource identifier to a profile-policy server;
upon receiving a denial, displaying a warning or informational message; and
upon not receiving a denial, applying a protocol to the resource identifier to request the resource from its server.

11. The method of claim 10 wherein a resource identifier is one of a link, url, redirection, and manual entry.

12. A method for operating a content category server for policy controlled client access, the method comprising:
upon receiving a request for resources located at an uncategorized resource identifier,
storing the uncategorized resource identifier with the category set to uncategorized,
determining one or more server host-ids evoked by the uncategorized resource identifier;
requesting a resource as a conventional browser,
checking for malicious code execution,
checking for a series of redirections,
receiving content as a conventional browser would,
applying spam and virus rules,
assigning a category to the resource identifier and storing it to the lookup table,
returning the category to the client or the profile policy server;
upon receiving a request for resources located at a categorized resource identifier,
determining the content category profile of the authenticated user;
determining the category of the resource identifier;
manifesting a warning or informative message when the host-id denied to the user because of its category and the user's profile policy; and
enabling access to the categorized resource when the host-id is not denied to the user because of its category and the user's profile policy.
